(19) United States
(12) Patent Application Publication
(10) Pub. No.: US 2025/0348863 A1
(43) Pub. Date: Nov. 13, 2025

(54) AGRICULTURAL CREDIT TRACKING SYSTEM AND METHOD FOR TRACKING OF A LINE OF CREDIT GROUNDED IN THE FARM CREDIT SYSTEM

(71) Applicant: BUSHEL, Inc., Fargo, ND (US)

(72) Inventor: Damon Larson, Fargo, ND (US)

(21) Appl. No.: 18/662,407

(22) Filed: May 13, 2024

(51) Int. Cl. G06Q 20/36; G06Q 20/40; G06Q 40/03

(52) U.S. Cl. CPC G06Q 20/36; G06Q 20/4014; G06Q 40/03

(57) ABSTRACT

A processor implemented method for agricultural credit tracking of a line of credit (LOC) grounded in the Farm Credit according to one disclosed non-limiting embodiment of the present disclosure includes setting up an electronic wallet interface in an agricultural credit tracking system for a user; verifying the user of the electronic wallet interface; associating the user with a line of credit (LOC) grounded in the Farm Credit System (FCS) through an Agricultural Credit Association (ACA) in the Farm Credit System (FCS); permitting access to the line of credit (LOC) via the electronic wallet; and allowing spending via the electronic wallet.

### CROSS REFERENCE TO RELATED APPLICATION[S]

None

### BACKGROUND

The present disclosure relates to lines of credit utilized by agricultural entities, and, more particularly, to a system and a method for verifying tracking and using the line of credit available to an agricultural entity in conjunction with the Farm Credit System (FCS).

Agriculture is a dominant sector for the economies of many nations and credit plays an important role in increasing agriculture production. Availability and access to adequate, timely and low-cost credit from institutional sources is of great importance.

The Farm Credit System (FCS) in the United States is a nationwide network of borrower-owned lending institutions and specialized service organizations. Congress established the Farm Credit System in 1916 to provide a reliable source of credit for farmers and ranchers.

With reference to FIG. 1, the Farm Credit System (FCS) includes four Farm Credit Banks (FCBs: AgFirst Farm Credit; AgriBank; CoBank Farm Credit Bank of Texas) that provide loan funds to numerous (67) Agricultural Credit Associations (ACAs) and one Federal Land Credit Association (FLCA). In turn, ACAs make short-, intermediate-, and long-term loans, while FLCA make long-term loans, available to users such as farmers, ranchers, producers and harvesters of aquatic products, rural residents for housing, and certain farm-related businesses who can then use that line of credit to pay vendors with draft books specific to that line of credit.

### SUMMARY

A processor implemented method for agricultural credit tracking of a line of credit (LOC) grounded in the Farm Credit System (FCS) according to one disclosed non-limiting embodiment of the present disclosure includes setting up an electronic wallet interface in an agricultural credit tracking system for a user; verifying the user of the electronic wallet interface; associating the user with a line of credit (LOC) grounded in the Farm Credit System (FCS) through an Agricultural Credit Association (ACA) in the Farm Credit System (FCS); permitting access to the line of credit (LOC) via the electronic wallet; and allowing spending via the electronic wallet.

A further embodiment of any of the foregoing embodiments of the present disclosure includes that verifying the user includes using user provided data provided by the user to return borrower information from the Agricultural Credit Association (ACA); matching the user provided data to that returned from the Agricultural Credit Association (ACA); and determining a confidence score from the matching.

A further embodiment of any of the foregoing embodiments of the present disclosure includes that verifying the user manually below a predetermined confidence score.

A further embodiment of any of the foregoing embodiments of the present disclosure includes that associating the user with a demand deposit account, the demand deposit account accessible via the electronic wallet.

A further embodiment of any of the foregoing embodiments of the present disclosure includes that allowing spending from the electronic wallet interface via at least one of a wire, a transfer, an ACH, a debit card, or check.

A further embodiment of any of the foregoing embodiments of the present disclosure includes that communicating between the electronic wallet interface and the Agricultural Credit Association (ACA) to determine a balance associated with the line of credit (LOC) available via the electronic wallet.

A further embodiment of any of the foregoing embodiments of the present disclosure includes that communicating between the electronic wallet interface and the Agricultural Credit Association (ACA) at predetermined intervals.

A further embodiment of any of the foregoing embodiments of the present disclosure includes the communicating includes querying the Agricultural Credit Association (ACA) regarding the balance of the line of credit outside of the electronic wallet.

A further embodiment of any of the foregoing embodiments of the present disclosure includes that communicating includes querying transaction data from the electronic wallet.

A processor implemented method for agricultural credit tracking of a line of credit (LOC) grounded in the Farm Credit System (FCS) according to one disclosed non-limiting embodiment of the present disclosure includes setting up an electronic wallet interface in an agricultural credit tracking system for a user; associating the user with a line of credit (LOC) grounded in the Farm Credit System (FCS) through an Agricultural Credit Association (ACA) in the Farm Credit System (FCS); permitting access to the line of credit (LOC) via the electronic wallet; and allowing spending via the electronic wallet with funds from the line of credit (LOC).

A further embodiment of any of the foregoing embodiments of the present disclosure includes that communicating between the electronic wallet interface and the Agricultural Credit Association (ACA) to determine a balance associated with the line of credit (LOC) available via the electronic wallet.

A further embodiment of any of the foregoing embodiments of the present disclosure includes that communicating between the electronic wallet interface and the Agricultural Credit Association (ACA) at predetermined intervals.

A further embodiment of any of the foregoing embodiments of the present disclosure includes that the communicating includes querying the Agricultural Credit Association (ACA) regarding the balance of the line of credit outside of the electronic wallet.

A further embodiment of any of the foregoing embodiments of the present disclosure includes that the communicating includes querying transaction data from the electronic wallet.

A processor implemented method for agricultural credit tracking of a line of credit (LOC) from an Agricultural Credit Association (ACA) grounded in the Farm Credit System (FCS) according to one disclosed non-limiting embodiment of the present disclosure includes setting up an electronic wallet interface in an agricultural credit tracking system for a user; and verifying the user of the electronic wallet interface.

A further embodiment of any of the foregoing embodiments of the present disclosure includes that verifying the user includes using line of credit (LOC) data provided by the user to return borrower information from the Agricultural Credit Association (ACA); matching the user provided data to that returned from the Agricultural Credit Association (ACA); and determining a confidence score from the matching.

A further embodiment of any of the foregoing embodiments of the present disclosure includes verifying the user manually below a predetermined confidence score.

A further embodiment of any of the foregoing embodiments of the present disclosure includes associating the user with the line of credit (LOC) grounded in the Farm Credit System (FCS) through the Agricultural Credit Association (ACA) in the Farm Credit System (FCS).

A further embodiment of any of the foregoing embodiments of the present disclosure includes allowing spending via the electronic wallet with funds from the line of credit (LOC).

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of a Farm Credit System (FCS) from which a user may utilize funds from a line of credit (LOC) grounded in the Farm Credit System (FCS) in a conventional PRIOR ART manner.

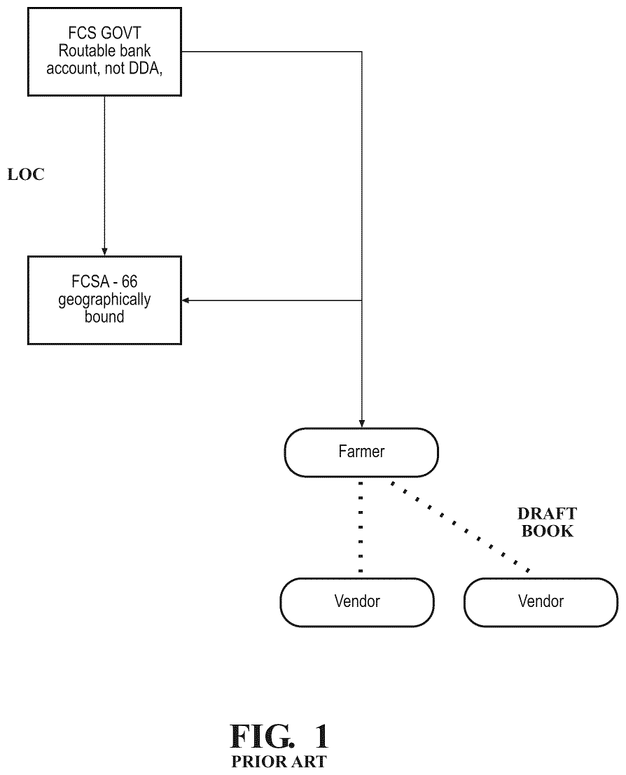

FIG. 2 is a schematic view of an agricultural credit tracking system utilizing an electronic wallet interface according to one disclosed non-limiting embodiment.

FIG. 3 is a schematic view of an example hardware platform for the agricultural credit tracking system according to one disclosed non-limiting embodiment.

FIG. 4 is a flow chart illustrating the operation of the Farm Credit System (FCS) in conjunction with the agricultural credit tracking system according to one disclosed non-limiting embodiment.

FIG. 5 is a flow chart illustrating setup of an electronic wallet interface for the agricultural credit tracking system according to one disclosed non-limiting embodiment.

FIG. 6 is a flow chart illustrating user identification for use of the electronic wallet interface for the agricultural credit tracking system according to one disclosed non-limiting embodiment.

FIG. 7 is a flow chart illustrating communication by the electronic wallet interface for the agricultural credit tracking system according to one disclosed non-limiting embodiment.

FIG. 8 is an expanded flow chart illustrating communication by the electronic wallet interface for the agricultural credit tracking system according to one disclosed non-limiting embodiment.

FIG. 9 is a flow chart illustrating spending facilitated by the electronic wallet interface for the agricultural credit tracking system according to one disclosed non-limiting embodiment.

### DETAILED DESCRIPTION

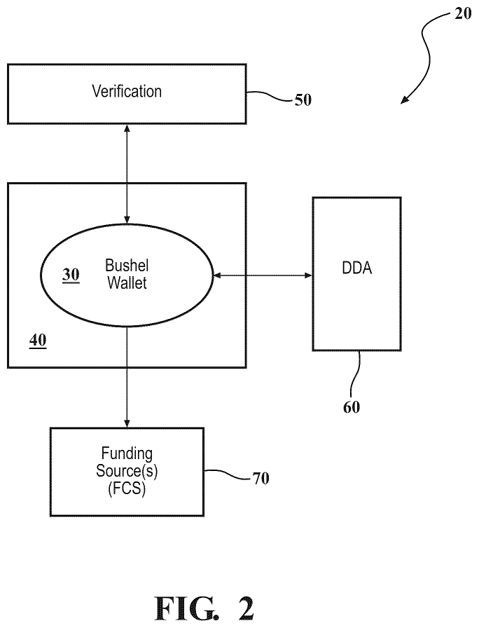

FIG. 2 schematically illustrates an agricultural credit tracking system 20 for users such as farmers, ranchers, rural homeowners, aquatic producers, timber harvesters, agribusinesses, and agricultural and rural utility cooperatives, etc. The agricultural credit tracking system 20 operates to transfer verified funds via an electronic wallet interface 30 (i.e., Bushel Wallet), that runs on a platform 40 (i.e., Bushel Platform) to operate as an interface between a verification module 50, a demand deposit account (DDA) 60 and a funding source 70 such as that associated with the Farm Credit System (FCS), which is not a bank, and utilizes a line of credit (LOC) based system.

The agricultural credit tracking system 20 facilitates verification, management, and utilization of the line of credit (LOC) based system grounded on the Farm Credit System (FCS) which itself does not provide direct checking, or other common services typical of a bank. That is, the Farm Credit System (FCS) provides the government backed line of credit (LOC) funding source, however, management of funds, e.g., payments, balances, etc., from the line of credit (LOC) funding source are performed by the user via the agricultural credit tracking system 20 which operates to verify and transfer payments in an electronic manner.

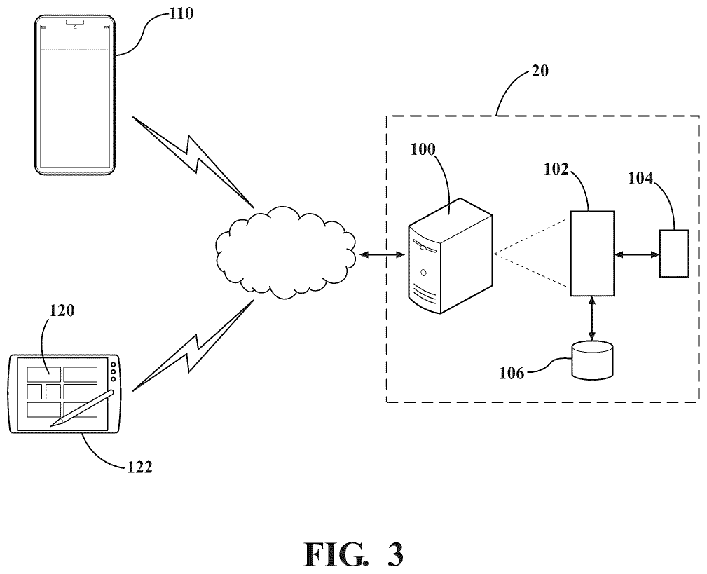

With reference to FIG. 3, the platform 40 (i.e., Bushel Platform) may generally include a server 100, a client-facing website 110, and/or a client-facing mobile app 120 on a handheld device 122. The server 100 may include computing device hardware (e.g., servers, processors, processing devices, workstation, mainframes, network, etc.) and/or software that provide data and computation functionality services to programs, models, and devices via a request-response methodology. The server 100 may include memory storing computer executable programs, such as the electronic wallet interface (i.e., Bushel Wallet) 30, executed by one or more processors to implement the functionality described herein. The server 100 may also include communications interface s with external components. The term “server” conveys its customary meaning that provides service and/or data connection to, for example, the client-facing website 110, and/or the client-facing mobile app 120 through a network such as the internet.

In an embodiment, the server 100 may include one or more hardware processors 102, one or more memory devices 104, and a data repository 106. The memory devices 104 may be in communication with the one or more hardware processors 102, wherein the one or more hardware processors 102 are configured to execute programmed instructions stored in the memory devices 104, to perform various functions as explained herein. The data repository 106 may be an organized collection of data that includes database management systems that allow for manipulation of data through update and retrieval for use by the server 100.

The client-facing website 110 may be a website published on a web server and available publicly via the internet. Alternatively, or in addition, the client-facing website 110 may be configured to include private access to the particular clients, via, for example, a password protected section to communicate client input data. The client-facing mobile app 120 may be a client facing mobile software application configured to communicate with the server 100 to communicate client input data. The client-facing mobile app 120 may be installed on the handheld device 122.

The server 100 communicates with the client-facing website 110, and/or the client-facing mobile app 120 through any desired method of communications, including, for example, an SMS, MMS, cellular, GSM, CDMA, Wi-Fi, Wi-Max, wireless transmission, the Internet, LAN, WAN, email, telephone, and any wired or wireless paths or combinations thereof. The term “handheld device” refers to a portable electronic device that is at least configured to send messages to, and/or receive messages from the listing recommendation server over a long-range wireless communication network, such as a SMS, wireless, or cellular network. Examples of handheld devices include, but are not limited to, a mobile phone, a tablet, a portable computer, etc.

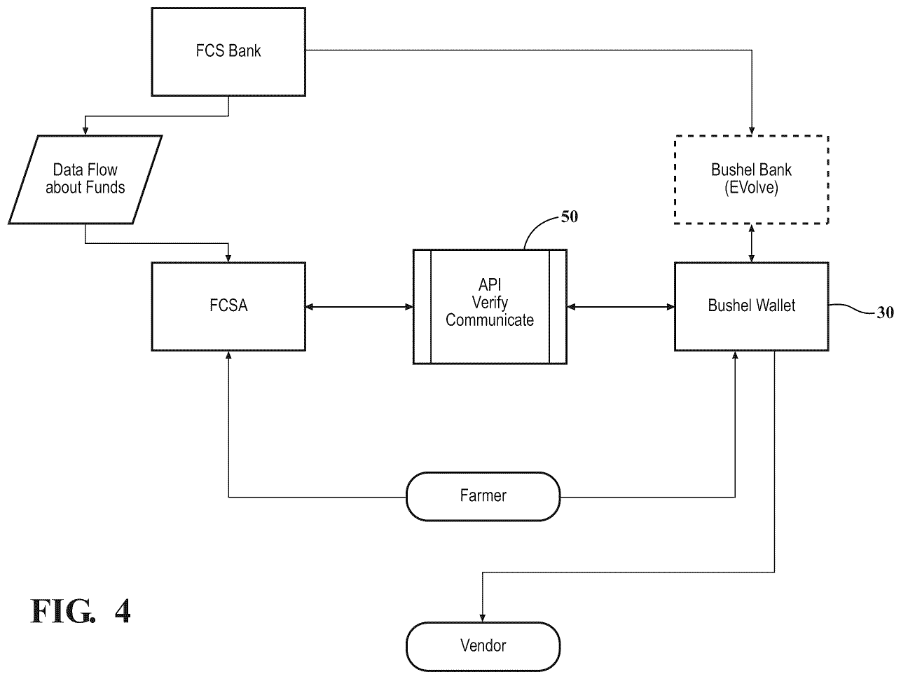

With reference to FIG. 4, the server 100 runs the platform 40 (i.e., Bushel Platform) and the electronic wallet interface 30 (i.e., Bushel Wallet) to provide communication and data transfer between the verification module 50, the demand deposit account (DDA) 60, and the funding source 70. The electronic wallet interface 30 (i.e., Bushel Wallet) operates as a management and utilization tool for the user who ultimately has a line of credit (LOC) grounded on the Farm Credit System (FCS) through the local Agricultural Credit Association (ACA).

The platform 40 (i.e., Bushel Platform) processes the data and communicates with the electronic wallet interface 30 (i.e., Bushel Wallet) which is interface d by the user via the client-facing website 110, and/or the client-facing mobile app 120 to provide real time balances, payments, transactions, etc., via the electronic wallet interface (i.e., Bushel Wallet) 30. For example, the electronic wallet interface 30 (i.e., Bushel Wallet) allows a user to electronically transfer funds (may be referred to herein as “to Bushel funds”) to a vendor from the line of credit (LOC) such that the actual funds are then immediately accessible by the vendor to pay for, again for example, a supply material who need not otherwise be associated with the Farm Credit System (FCS). That is, the agricultural credit tracking system 20 facilitates verification, management, and utilization of the line of credit (LOC) via electronic transfers and other common services typical of a bank which have not been heretofore available.

The platform 40 (i.e., Bushel Platform) may communicate with the verification module 50 in conjunction with a third-party financial management products company such as, for example, PLAID, which although not operable with line of credit (LOC) does provide a third-party unified banking Application Programing Interface (API) to connect bank accounts with the electronic wallet interface (i.e., Bushel Wallet) 30. The verification module 50 may operate as an interface that gathers data and may be separate than the electronic wallet interface (i.e., Bushel Wallet) 30.

The verification module 50 may be used to verify the user and connect external funding sources such as bank accounts, line of credit (LOC), and demand deposit account (DDA) 60 with the electronic wallet interface 30 (i.e., Bushel Wallet) such that the user may interact with their bank accounts, check balances, and make payments through various financial technology application. Once funds are in the electronic wallet interface 30 (i.e., Bushel Wallet) the funds, irrespective of the source, such as the line of credit (LOC), can then be readily wired, spent via debt, transferred, etc. That is, the agricultural credit tracking system 20 ingests lines of credit as a funding source for use by the electronic wallet interface (i.e., Bushel Wallet) 30.

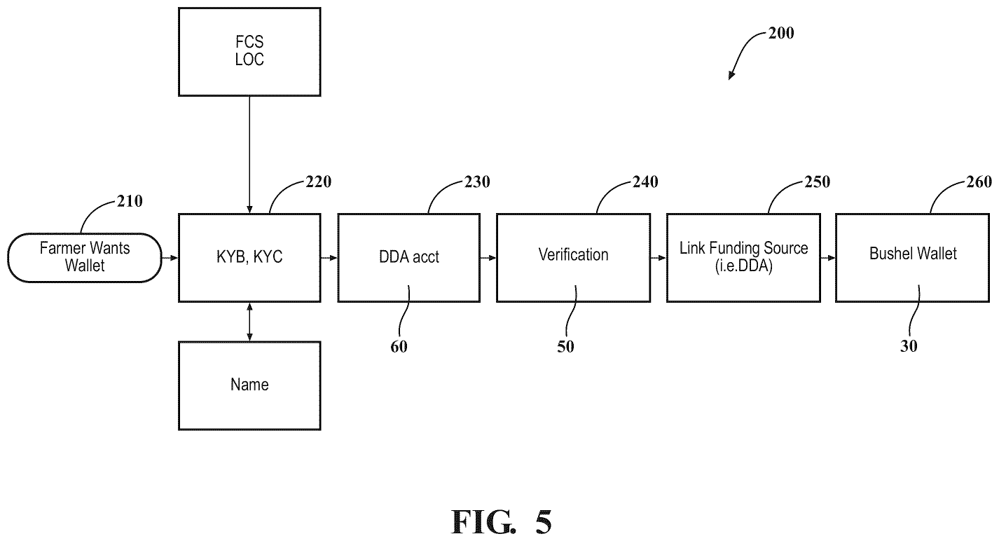

With reference to FIG. 5, a method 200 to setup the electronic wallet interface 30 (i.e., Bushel Wallet) of the agricultural credit tracking system 20 is schematically illustrated. In embodiments, the user submits identification 210 to the platform 40 (i.e., Bushel Platform) for comparison with various “know your business” (KYB), “know your customer” (KYC) confirmation logic (220) to identify the user and associate the user with their line of credit (LOC) grounded on the Farm Credit System (FCS) through the Agricultural Credit Association (ACA). That is, the confirmation that the line of credit (LOC) is associated with the particular user is confirmed.

The user may then be associated (230) with one or more desired demand deposit accounts (DDAs) 60. Once their line of credit (LOC) and their demand deposit account (DDA) 60 is associated, the platform 40 (i.e., Bushel Platform) may then use the verification module 50 to verify (240) then link (250) one or more funding sources and/or customer payment destinations for the then transactable (260) electronic wallet interface (i.e., Bushel Wallet) 30.

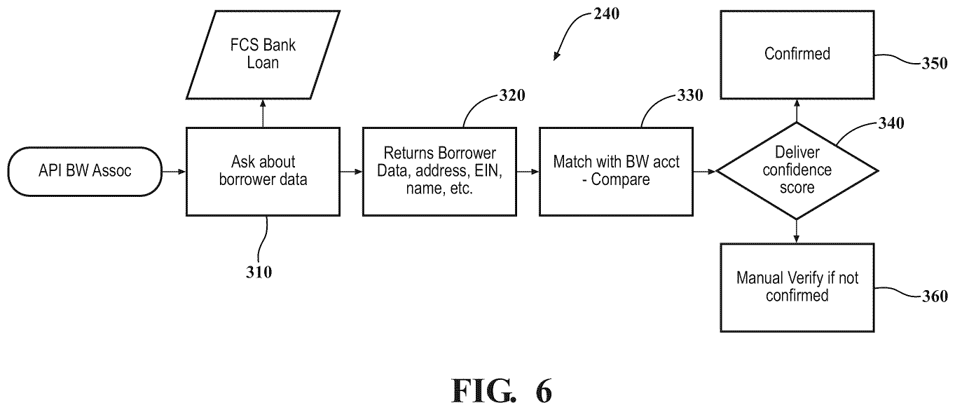

With reference to FIG. 6, in one embodiment, the verification (240) and association of the user with their line of credit (LOC) grounded on the Farm Credit System (FCS) through the Agricultural Credit Association (ACA) may be performed through the client-facing website 110 and/or the client-facing mobile app 120.

Initially, the user submits data information (310) regarding their Business (EIN, biz name, address, beneficial owner info, etc.) for the purpose of the platform 40 (i.e., Bushel Platform) performing KYB/KYC confirmation logic to verify their business identity so as to establish their Wallet Account (and the underlying bank DDA).

The user then submits to the platform 40 (i.e., Bushel Platform) the loan number and the FCS Association to which they desire to establish a linking. The platform 40 (i.e., Bushel Platform) then queries the Association for the Loan Details (which include Loan Borrower Details) for the requested loan in their system(s), which is then ultimately compared to the business data that was KYC/KYB confirmation logic. The data information provided to the agricultural credit tracking system 20 is then used to return (320) the associated borrower information from the institution. The information is then matched (330) with user data provided to the platform 40 (i.e., Bushel Platform) to determine a confidence score (340). Various mathematical confidence algorithms may be utilized to determine the confidence score (340) which may then be directly confirmed (350) and/or manually verified (360) such that the electronic wallet interface 30 (i.e., Bushel Wallet) is setup and available to the user and the line of credit (LOC) is a linked funding source.

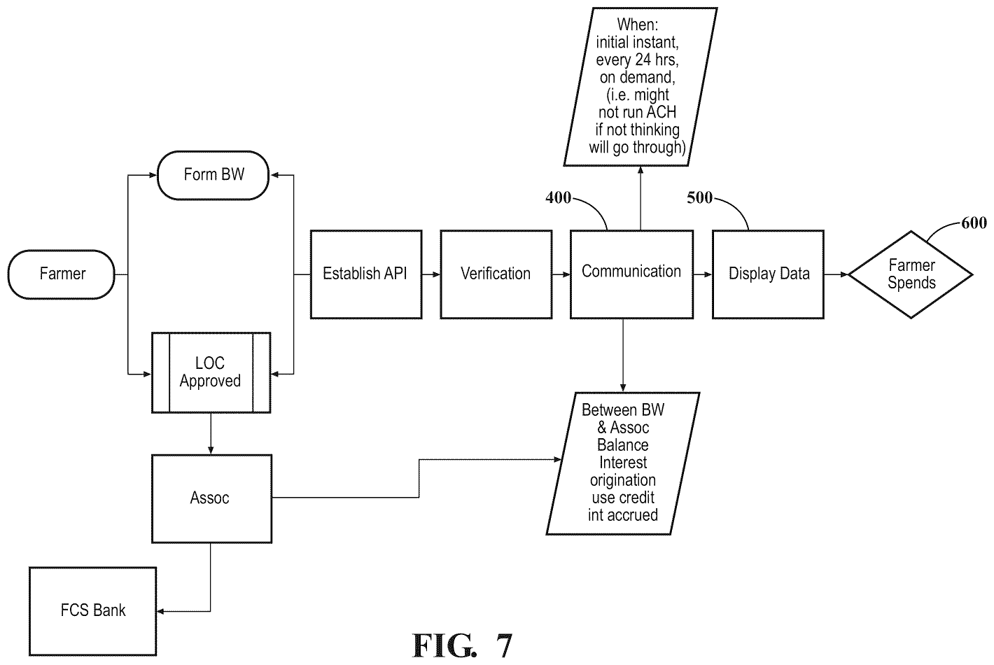

With reference to FIG. 7, once the electronic wallet interface 30 (i.e., Bushel Wallet) has been setup and is available to the proper user, and the line of credit (LOC) of the user exists, the electronic wallet interface 30 (i.e., Bushel Wallet) is now in communication 400 with the Agricultural Credit Association (ACA) regarding the balance of the line of credit (LOC) grounded on the Farm Credit System (FCS). The electronic wallet interface 30 (i.e., Bushel Wallet) remains in communication with the Agricultural Credit Association (ACA) but not otherwise the Farm Credit System (FCS) from which the line of credit (LOC) originates. In other words, the electronic wallet interface 30 (i.e., Bushel Wallet) interfaces with Agricultural Credit Associations (ACA) to establish a linked funding source which is tracked essentially as a bank account.

The electronic wallet interface 30 (i.e., Bushel Wallet) is now in communication 400 with the Agricultural Credit Association (ACA) regarding the balance of the line of credit (LOC) as the line of credit (LOC) may change over time, e.g., interest, additional funding, spending, etc. For example, the user may disperse funds from the line of credit (LOC) in other non-electronic manners such as by writing a direct paper check.

In one embodiment, the communication 400 occurs, for example, the instant a transition occurs from the electronic wallet interface (i.e., Bushel Wallet) 30, every 24 hours, etc. In other embodiments, the communication 400 occurs as Bushel may also communicate with the FCS Association: a) initially upon the user desiring to establish a LoC linking; b) on demand when either: b-1) the user uses wallet to view/manage his LoC or b-2) when a payment is initiated from the LoC; and/or c) regularly every 24 hrs otherwise. The communication (400) assures the electronic wallet interface 30 (i.e., Bushel Wallet) is up to date in essentially real time for display (500) and spending (600) as the balance of the line of credit (LOC) changes.

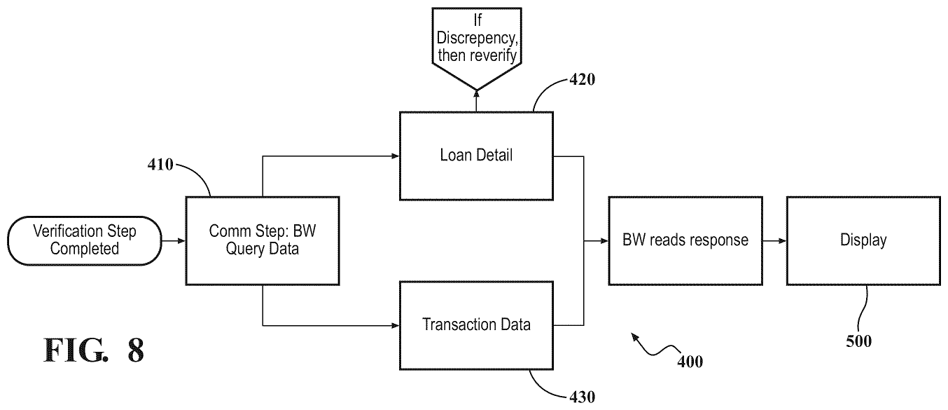

With reference to FIG. 8, the communication 400 may include data integration in which includes querying (410) of the Agricultural Credit Association (ACA) regarding the balance of the line of credit (LOC) (420) outside of the electronic wallet interface 30 (i.e., Bushel Wallet) and the transaction data (430) such as from within the electronic wallet interface (i.e., Bushel Wallet) 30. The platform 40 (i.e., Bushel Platform) thereby uses the communication (400) to assure the electronic wallet interface 30 (i.e., Bushel Wallet) is up to date and the proper funds are available.

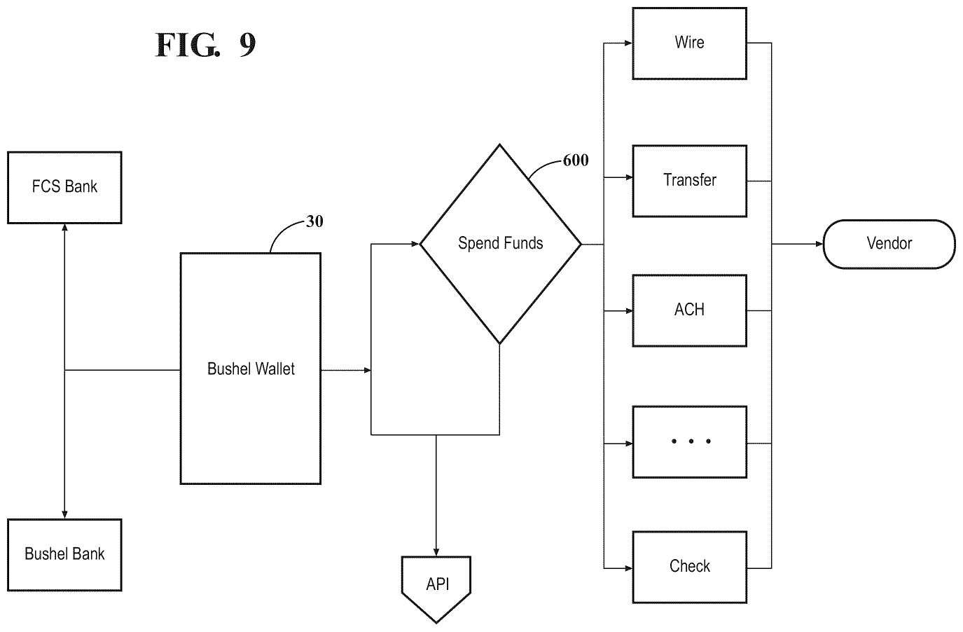

With reference to FIG. 9, the user may spend 600 in any conventional manner using conventional services, e.g., wire transfers, Automated Clearing House (ACH) networks, checks, debit card, etc., as the electronic wallet interface 30 (i.e., Bushel Wallet) is up to date and the proper funds are available in a real time manner. The spending 600 may occur electronically in various manners from the typically one or more line(s) of credit (LOC) grounded on the Farm Credit System (FCS) which does not provide such convenient services.

In examples, a transfer may be made via the electronic wallet interface 30 (i.e., Bushel Wallet) to the demand deposit account (DDA) then spent.

In another example, a payment may be made directly to a vendor via the electronic

wallet interface (i.e., Bushel Wallet) 30. In this example, notifications such as, for example, an email and/or text notification may be provided to the user.

In still another example, a transfer from the line of credit (LOC) may be made to the electronic wallet interface 30 (i.e., Bushel Wallet) then to final destination, e.g., can be wired, spent via debt.

In still another example, a direct authorization on the platform 40 (i.e., Bushel Platform) and atheization against the LoC balance at another institution may be used with the debit card as a form of spending.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason, the appended claims should be studied to determine true scope and content.

1. A magnetic joint, comprising:
a first component having a first interface;
a second component having a second interface;
a first magnet adjacent to the first interface; and
a spherical magnet within a non-spherical cavity formed in the second component, the non-spherical cavity adjacent to the second interface and is conformal with respect to the second interface, the second interface at least partially fits within the first interface and the spherical magnet movable within the non-spherical cavity such that the spherical magnet is attracted to the first magnet to retain the first component to the second component such that the second component is articulatable with respect to the first component.

2. (canceled)

3. (canceled)

4. (canceled)

5. (canceled)

6. (canceled)

7. (canceled)

8. The magnetic joint as recited in claim 1, wherein the first component is a first bone and the second component is a second bone adjacent to the first bone.

9. The magnetic joint as recited in claim 1, wherein the first component and the second component are adjacent components of an articulatable figure.

10. The magnetic joint as recited in claim 1, wherein the first component and the second component are adjacent components of a skeleton.

11. A magnetic joint for an articulatable figure, comprising:
a first component having a first interface;
a second component having a second interface, the second interface adjacent to the first interface the second component an articulatable portion of the articulatable figure;
a first magnet adjacent to the first interface; and
a spherical magnet within a non-spherical cavity formed in the second component, the non-spherical cavity adjacent to the second interface and conformal with respect to the second interface, the spherical magnet movable within the non-spherical cavity such that the spherical magnet is attracted to the first magnet to retain the first component to the second component such that the second component is articulatable with respect to the first component.

12. The magnetic joint as recited in claim 11, wherein the first component is a torso and the second component is an arm.

13. The magnetic joint as recited in claim 11, wherein the first component is a torso and the second component is a leg.

14. The magnetic joint as recited in claim 11, wherein the first component is thigh and the second component is a lower leg.

15. The magnetic joint as recited in claim 11, wherein the first component is an upper arm and the second component is a forearm.

16. The magnetic joint as recited in claim 11, wherein the second interface at least partially fits within the first interface.

17. A magnetic joint for a skeleton, comprising:
a first bone having a first interface;
a second bone having a second interface, the second interface adjacent to the first interface, the second bone an articulatable portion of the skeleton;
a first magnet adjacent to the first interface; and
a spherical magnet within a non-spherical cavity formed in the second bone, the non-spherical cavity adjacent to the second interface and conformal with respect to the second interface, the spherical magnet movable within the non-spherical cavity such that the spherical magnet is attracted to the first magnet to retain the first bone to the second bone such that the second bone is articulatable with respect to the first bone.

18. The magnetic joint as recited in claim 17, wherein the first bone and the second bone are synthetic.

19. (canceled)

20. (canceled)

21. The magnetic joint as recited in claim 1, wherein the first magnet is partially exposed at the first interface.

22. The magnetic joint as recited in claim 1, wherein the first magnet is completely hidden within the first component.
